(19) United States
(12) Patent Application Publication
(10) Pub. No.: US 2021/0195045 A1
(43) Pub. Date: Jun. 24, 2021

(54) IMAGE FORMING APPARATUS TO DETECT USER AND METHOD FOR CONTROLLING THEREOF

(71) Applicant: Hewlett-Packard Development Company, L.P., Spring, TX (US)

(72) Inventors: Suhwan KIM, Seongnam-si (KR); Sae Jin PARK, Seongnam-si (KR)

(21) Appl. No.: 17/051,865

(22) PCT Filed: Oct. 17, 2018
(86) PCT No.: PCT/KR2018/012277

§ 371 Date: Oct. 30, 2020

(30) Foreign Application Priority Data
Jun. 5, 2018 (KR) 10-2018-0064599

(51) Int. Cl. H04N 1/00; H04N 5/33

(52) U.S. Cl. CPC H04N 1/00891; H04N 1/00896; H04N 5/33

(57) ABSTRACT

An image forming apparatus and method for detecting a user are provided. The image forming apparatus includes a print engine to form an image, a thermal image sensor to measure thermal image information for each of a plurality of regions partitioned within a preset region, and a processor to detect a user using the measured thermal image information and switch an operation state of the image forming apparatus according to a user detection state. The processor detects the user using thermal image information of remaining regions other than a region that deviates from a preset thermal image range among the plurality of regions.

### BACKGROUND ART

An image forming apparatus may refer to an apparatus which prints print data generated in a terminal apparatus such as a computer on a recording paper. For example, the image forming apparatus may include a copier, a printer, a scanner, a facsimile, a multifunction peripheral (MFP) in which functions of the copier, the printer, the scanner, and the facsimile are integrated into one apparatus, and the like.

To reduce power consumption, an image forming apparatus may support a power saving mode in which a user command stands by with low power consumption when a user does not use the image forming apparatus.

### DISCLOSURE OF INVENTION

### Brief Description of Drawings

The above and/or other aspects of the present invention will be more apparent by describing certain examples of the present invention with reference to the accompanying drawings, in which:

FIG. 1 is a schematic block diagram illustrating a configuration of an image forming apparatus according to an example;

FIG. 2 is a block diagram illustrating a configuration of an image forming apparatus according to an example;

FIG. 3 is a diagram illustrating a configuration of a print engine, such as the print engine of FIG. 1, according to an example;

FIG. 4 is a diagram illustrating an arrangement position of a sensor according to an example;

FIG. 5 is a diagram illustrating thermal image information measured through a thermal image sensor according to an example;

FIG. 6 is a diagram explaining an operation of detecting a user using pre-stored thermal image information according to an example;

FIG. 7 is a flowchart explaining a control method according to an example;

FIG. 8 is a flowchart explaining a method of updating background temperature information according to an example;

FIG. 9 is a flowchart explaining a method of updating background temperature information according to another example;

FIG. 10 is a flowchart explaining a method of correcting background temperature information used for user detection according to an example; and

FIG. 11 is a flowchart explaining a method of correcting background temperature information used for user detection according to another example.

Throughout the drawings, it should be noted that like reference numbers are used to depict the same or similar elements, features, parts, components, and structures.

### MODE FOR THE INVENTION

Hereinafter, examples of the disclosure will be described more fully with reference to the accompanying drawings. The disclosure may, however, be embodied and modified in many different forms and should not be construed as limited to the examples set forth herein. To more clearly describe features of the examples, detailed description for contents widely known to those skilled in the art will be omitted for clarity.

It will be understood that when an element (for example, a first element) is referred to as being “coupled with/to” or “connected to” another element (for example, a second element), it can be directly connected or coupled to the other element or intervening elements (for example, third elements) may be present. Unless otherwise described, any portion including any element may refer to the portion further including other elements not excluding the other elements.

In the disclosure, the term “image forming job” may refer to various jobs (for example, copy, print, scan, or facsimile) related to an image such as image formation or generation/storage/transmission of an image file and the term “job” may refer to an image forming job as well as a series of processes required for performing the image forming job.

The term “image forming apparatus” may refer to an apparatus which prints print data generated in a terminal apparatus such as a computer on a recording paper. For example, the image forming apparatus may include a copier, a printer, a facsimile, a scanner, a multifunction peripheral (MFP) in which functions of the copier, the printer, the scanner, and the facsimile are integrated into one apparatus, and the like. In another example, the image forming apparatus may refer to any apparatus which may perform an image forming job such as a copier, a printer, a scanner, a fax machine, an MFP, a display apparatus, and the like.

The term “hard copy” may refer to an operation which outputs an image to a print medium such as paper and the term “soft copy” may refer to an operation which outputs an image to a display apparatus such as a television (TV) or a monitor or to a memory.

The term “content” may refer to any kind of data which is a target of an image forming job such as a photo, an image, a document file, and the like.

The term “print data” may refer to data converted into a printable format in an image forming apparatus. When the image forming apparatus supports directing printing, the file itself may be the print data.

The term “user” may refer to a person who performs an operation related to an image forming job using an image forming apparatus or a device coupled to the image forming apparatus in a wireless or wired manner. The term “manager” may be a person who has authority to access all functions of the image forming apparatus and a system. The “user” and the “manager” may be the same person.

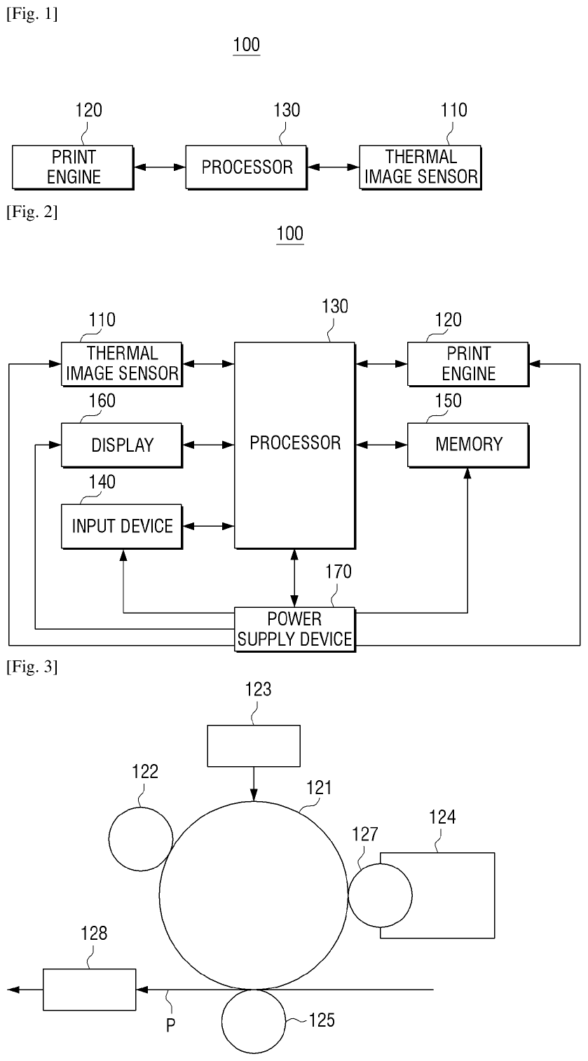

FIG. 1 is a schematic block diagram illustrating a configuration of an image forming apparatus according to an example.

Referring to FIG. 1, an image forming apparatus 100 may include a thermal image sensor 110, a print engine 120, and a processor 130.

The thermal image sensor 110 may measure thermal image information within a preset region. For example, the thermal image sensor 110 may be disposed in a front of the image forming apparatus 100 and measure the thermal image information within the preset region. The preset region may be a spatial range according to an inherent sensing distance in which the sensor may detect a user and an arrangement position of the sensor.

The thermal image sensor 110 may measure thermal image information of each of a plurality of regions partitioned within the preset region. As will be discussed with reference to FIG. 5, the thermal image sensor 110 may measure the thermal image information of each of the plurality of regions (for example, 49 (=7*7) regions) partitioned within the preset region. The thermal image information may have a two-dimensional (2D) matrix structure.

The matrix structure of the thermal image information may have a structure in which a number of rows is equal to a number of columns, but the matrix structure is not limited thereto. That is, the matrix structure of the thermal image information may have a structure in which the number of rows is different from the number of columns, a one-row array, or a one-column array structure.

The thermal image sensor 110 may measure the thermal image information within the preset region when the image forming apparatus 100 is in an on state or the thermal image sensor 110 may periodically measure the thermal image information within the preset region in preset time period units.

The print engine 120 may form an image. The print engine 120 may form the image in a recording medium through various printing methods, for example, an electrophotographic method, an ink-jet method, a thermal transfer method, a thermosensitive method, and the like. For example, the print engine 120 may print an image in a recording medium through a series of processes including exposure, development, transfer, and fixing processes. An example configuration of the print engine 120 will be described later with reference to FIG. 3.

The processor 130 may control an operation of the image forming apparatus 100 and may be implemented with a central processing unit (CPU), an application specific integrated circuit (ASIC), and the like. In another example, the processor 130 may be configured as a plurality of CPUs. In this example, the processor 130 may include a main CPU configured to operate in a normal state and a stand-by state and perform a series of processes related to job execution and a sub CPU configured to operate with lower power consumption than the main CPU and perform only a simple control operation.

The processor 130 may detect a user using the thermal image information measured through the thermal image sensor 110.

For example, the processor 130 may determine regions that deviate from a preset thermal image range with respect to the thermal image information for each of the plurality of regions partitioned within the preset region, which is measured through the thermal image sensor 110, and detect the user using the remaining regions other than the determined regions.

For example, the preset thermal image range may be a range determined as a thermal image range suitable for detecting the user and may be determined as a result through a repetitive experiment. In another example, the preset thermal image range may be set to have a preset temperature range such as a range which does not exceed a maximum critical temperature, a range which is not smaller than a minimum critical temperature, a range between the maximum critical temperature and the minimum critical temperature, and the like.

A method of determining the region that deviates from the preset thermal image range and excluding the determined region may be performed using the measured thermal image information or thermal image information stored in a memory.

For example, when the measured thermal image information is used, the processor 130 may determine the regions that deviate from the preset thermal image range within the measured thermal image information. The processor 130 may exclude the determined regions from the measured thermal image information and detect the user using the remaining regions.

When the thermal image information stored in the memory is used, the processor 130 may determine the regions that deviate from the preset thermal image range within the pre-stored thermal image information. The processor 130 may determine information of the regions located in the same positions as the determined partial regions out of newly measured thermal image information, exclude the determined regions, and detect the user using the remaining regions.

As a method of excluding the determined regions, the thermal image sensor 110 may measure the thermal image information with respect to all of the plurality of regions partitioned within the preset region and the processor 130 may exclude the determined regions that deviate from the preset thermal image range out of the measured thermal image information.

As another method of excluding the determined regions, when the image sensor 110 measures the thermal image information, the processor 130 may control the thermal image sensor 110 not to measure thermal image information of the determined regions that deviate from the preset thermal image range. The method of excluding the determined region from the newly measured thermal image information is not limited thereto.

The measured thermal image information may have the 2D matrix structure as described above. The processor 130 may detect the user using the thermal image information of the remaining regions in column units.

For example, the processor 130 may calculate the average value of the thermal image information of the remaining regions in column units and detect the user using the calculated average value and the measured thermal image information. The method of using the information of the remaining regions in column units is not limited thereto.

The processor 130 may switch the operation state (or operation mode) of the image forming apparatus 100 according to the user detection state. For example, the processor 130 may switch the operation state of the image forming apparatus 100 to a normal state or a stand-by state when it is determined that the operation state of the image forming apparatus 100 is a power-saving state and the user is in an approaching state or an approached state.

The normal state may be a state in which the image forming apparatus 100 may immediately perform a job when power is applied to all the components within the image forming apparatus 100 and the job execution command (print, scan, copy, fax, and the like) of the user is input. The stand-by state may be a state in which the image forming apparatus 100 may not immediately perform a job with respect to the job execution command of the user since the power is applied to all the components within the image forming apparatus 100 as in the normal state, but a temperature of a fusing device (not shown) is maintained at a temperature lower than a temperature of the normal state, such as at a room temperature or an ambient temperature.

The processor 130 may switch the operation state of the image forming apparatus 100 to the power-saving state when it is determined that the operation state of the image forming apparatus 100 is the normal state or the stand-by state and the user is not detected.

However, when the image forming apparatus 100 is performing a job requested by the user, the processor 130 may not immediately switch the operation state of the image forming apparatus 100 to the power-saving state even in a state in which it is determined that the user moves away from the image forming apparatus 100 or the user is not detected and may switch the operation state of the image forming apparatus 100 to the power-saving state after the current performing job is completed.

It has been described that the image forming apparatus 100 has only one power-saving state. However, the image forming apparatus 100 may be implemented to have a plurality of power-saving states. The processor 130 may switch the operation state of the image forming apparatus 100 step by step.

For example, the image forming apparatus 100 may have a first power-saving state in which the power is not provided to the print engine 120 or to a display, a second power-saving state in which the power is provided to the display and is not provided to the print engine 120, and a third power-saving state in which the power is provided to the display and is provided to only a fusing device of the printer engine 120.

When it is determined that the user approaches the image forming apparatus 100 in the first power-saving state, the processor 130 may switch the operation state of the image forming apparatus 100 to the second power-saving state from the first power-saving state and the processor 130 may switch the operation of the image forming apparatus 100 to the normal state or the stand-by state from the second power-saving state when it is determined that the user continuously approaches the image forming apparatus 100 even after the switching to the second power-saving state. It has been described that the power-saving state is divided into two steps, but the image forming apparatus 100 may be implemented to divide the power-saving state into three steps or more.

It has been described that the partial components which operate in the power-saving state are only the display and the fusing device. However, the image forming apparatus 100 may be implemented such that other components such as a near field communication (NFC) communication device (not shown) configured to receive user authentication information may operate in the power-saving state.

When the job execution command is input from the user or the print data is received from an external apparatus, the processor 130 may perform the process with respect to the received job execution command or the received print data. For example, the processor 130 may perform the job by controlling a functional component corresponding to the job execution command of the user. In this example, when the job execution command of the user is a copy job, the processor 130 may control the scanner (not shown) to scan a document and control the print engine 120 to print the scanned document.

The processor 130 may control a power supply device to supply the power corresponding to the above-described power-saving state.

The above described image forming apparatus 100 according to an example may increase the accuracy in detection of a user by detecting the user using thermal image information of a remaining region other than regions that deviate from a preset thermal image range out of measured thermal image information. When the accuracy in the detection of the user is increased, the operation state of the image forming apparatus 100 may be switched to an operation state suitable for the actual surrounding status and thus the convenience of the user may be improved and the power consumption may be reduced.

Only a simple configuration of an image forming apparatus has been illustrated and described. However, the image forming apparatus may be implemented to include various additional components. An example configuration of an image forming apparatus will be described below with reference to FIG. 2.

FIG. 2 is a block diagram illustrating a configuration of an image forming apparatus according to an example.

Referring to FIG. 2, the image forming apparatus 100 may include a thermal image sensor 110, a print engine 120, a processor 130, an input device 140, a memory 150, a display 160, and a power supply device 170.

The thermal image sensor 110, the print engine 120, and the processor 130 in FIG. 2 may have the same configurations as the thermal image sensor 110, the print engine 120, and the processor 130 in FIG. 1, and thus overlapping descriptions will be omitted.

The input device 140 may receive a function selection from the user and a control command for the corresponding function. The function may include a print function, a copy function, a scan function, a facsimile transmission function, and the like. The input device 140 may receive the function selection and control command through a control menu displayed in the display 160.

The input device 140 may be implemented with a plurality of buttons, a key board, a mouse, and the like. The input device 140 may be implemented with a touch screen configured to simultaneously perform a function of the display 160 to be described later.

The input device 140 may include a power button configured to change the operation state of the image forming apparatus 100 and the power button may be implemented with a physical switch or a soft switch. According to the operation of the power button, the operation state of the image forming apparatus 100 may be immediately switched to the power-saving state from the normal state or the stand-by state or to the normal state or the stand-by state from the power-saving state.

The memory 150 may store an operating system of the image forming apparatus 100 or various types of data required for the operation of the operating system. The memory 150 may store print data received from an external apparatus (not shown), store scan data generated in a scanner (not shown), and store fax data received from a fax unit (not shown). The memory 150 may also store history information for the above-described jobs.

The memory 150 may store the thermal image information within the preset range measured in the thermal image sensor 110. Even when the image sensor 110 periodically measures the thermal image information in preset period units, the memory 150 may store the measured thermal image information.

The memory 150 may be implemented with either or both of a storage medium within the image forming apparatus 100 or an external storage medium (for example, a removable disc including a universal serial bus (USB), a storage medium coupled to a host, a web server through a network, and the like).

The display 160 may display various types of information provided from the image forming apparatus 100. For example, the display 160 may display a user interface window configured to receive a selection of various functions provided from the image forming apparatus 100. The display 160 may be a monitor such as a liquid crystal display (LCD), a cathode-ray tube (CRT), a light emitting diode (LED), an organic light emitting diode (OLED), and the like. The display 160 may be implemented with a touch screen configured to simultaneously perform the function of the input device 140.

The display 160 may display a control menu configured to perform a function of the image forming apparatus 100.

A display state of a screen in the display 160 may be changed according to the operation state of the image forming apparatus 100. For example, when the operation state of the image forming apparatus 100 is the normal state, the display 160 may display the control menu.

When the operation state of the image forming apparatus 100 is the power-saving state, the display 160 may not display the control menu. When the image forming apparatus 100 has a plurality of power-saving states in connection with the operation of the processor 130 as described above, the display 160 may perform a display operation in any one of the plurality of power-saving states and may stop the display operation in the other power-saving state.

The power supply device 170 may be configured to supply the power to the components within the image forming apparatus 100. For example, the power supply device 170 may receive a commercial alternating current (AC) power AC_IN from an external source and output direct current (DC) power DC_OUT by converting the AC power to the DC power having potential levels suitable for the components using a device such as a transformer, an inverter, a rectifier, and the like.

The power supply device 170 may optionally supply power to internal components of the image forming apparatus 100 according to the operation state of the image forming apparatus 100. The power supply device 170 may supply power to all the components of the image forming apparatus 100 in the normal state and the power supply device 170 may supply power to only some components of the image forming apparatus 100 in the power-saving state. When the image forming apparatus 100 has a plurality of power-saving states, the components supplied with power may be changed according to the power-saving state of the image forming apparatus 100.

Only general functions of the image forming apparatus 100 have been illustrated and described in FIGS. 1 and 2. However, the image forming apparatus 100 may further include a communication device configured to receive a print job, a scanner configured to perform a scan function, a fax unit configured to perform a fax transmission/reception function, and the like according to the function supported by the image forming apparatus 100 in addition to the above-described configuration of the image forming apparatus 100.

For example, the communication device (not shown) (e.g., a transceiver) may be coupled to a terminal device (not shown) such as a mobile device (e.g., a smart phone, a tablet personal computer (PC), a PC, a laptop PC, a personal digital assistant (PDA), a digital camera, and the like) and receive a file and print data from the terminal device.

The scanner (not shown) may scan a document and generate a scan image. The fax unit (not shown) may be configured to fax-transmit the scanned scan image or the received print data through a telephone network or an Internet network or receive fax data through the phone network or the Internet network.

FIG. 3 is a diagram illustrating a configuration of a print engine, such as the print engine of FIG. 1, according to an example.

Referring to FIG. 3, the print engine may include a photoconductive drum 121, a charging device 122, a laser scanning device 123, a developing device 124, a transfer device 125, and a fusing device 128.

An electrostatic latent image may be formed on the photoconductive drum 121. The photoconductive drum 121 may refer to a photoconductive drum, a photosensitive belt, and the like according to the type thereof.

For clarity, only a configuration example of the print engine 120 corresponding to a single color will be described hereinafter. However, the print engine 120 may be implemented to include a plurality of photoconductive drums 121, a plurality of charging devices 122, a plurality of laser scanning devices 123, and a plurality of developing devices 124 corresponding to a plurality of colors. In this example, the print engine may further include an intermediate transfer belt configured to form images formed on the plurality of photoconductive drums on one print paper.

The charging device 122 may charge a surface of the photoconductive drum 121 with a uniform potential. The charging device 122 may be implemented in a form of a corona charger, a charge roller, a charge brush, and the like.

The laser scanning device 123 may form the electrostatic latent image on the surface of the photoconductive drum 121 by changing the surface potential of the photoconductive drum 121 according to the image information to be printed. For example, the laser scanning device 123 may form the electrostatic latent image by irradiating light modulated according to the image information to be printed to the photoconductive drum 121. This type of laser scanning device 123 may refer to a light irradiator and the like and an LED may be used as a light source.

The developing device 124 may contain a developer in the inside thereof and develop the electrostatic latent image to a visible image by supplying the developer to the electrostatic latent image. The developing device 124 may include a developing roller 127 configured to supply the developer to the electrostatic latent image. For example, the developer may be supplied to the electrostatic latent image formed in the photoconductive drum 121 from the developing roller 127 through a developing field formed between the developing roller 127 and the photoconductive drum 121.

The visible image formed on the photoconductive drum 121 may be transferred to a recording medium P through the transfer device 125 or an intermediate transfer belt (not shown). The transfer device 125 may transfer the visible image onto the recording medium, for example, through an electrostatic transfer method. The visible image may be attached to the recording medium by the electrostatic attraction.

The fusing device 128 may fix the visible image onto the recording medium P by applying heat and/or pressure to the visible image on the recording medium P. The printing job may be completed through the series of processes.

The above-described developer may be used whenever the image forming job is performed and exhausted when the developer is used for a preset time or more. A device configured to store the developer (for example, the above-described developing device 124) itself may be newly replaced.

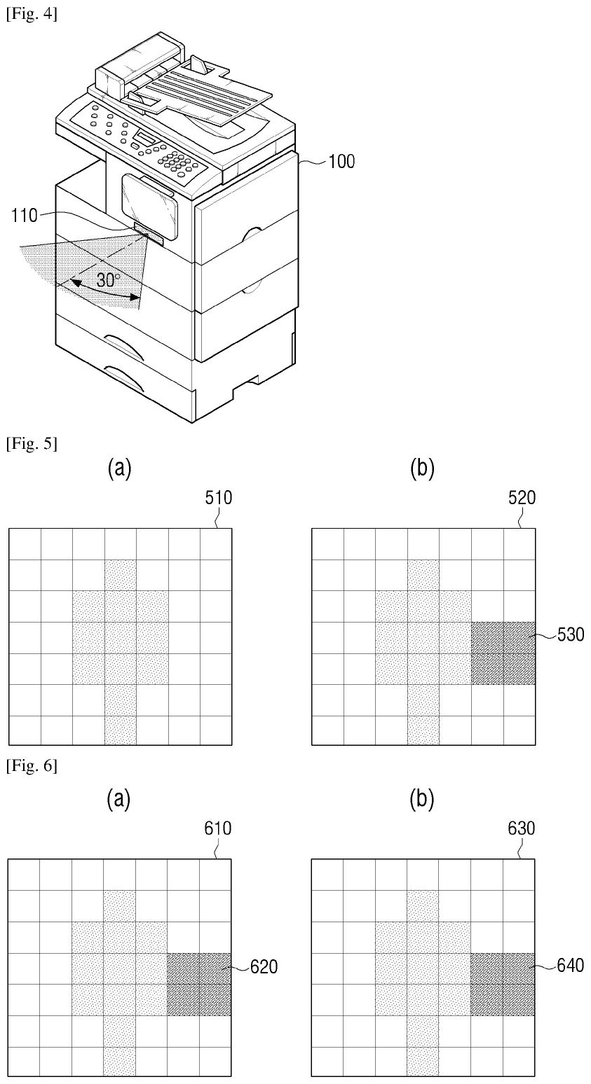

FIG. 4 is a diagram illustrating an arrangement position of a sensor according to an example.

Referring to FIG. 4, the thermal image sensor 110 may be located in a front of the image forming apparatus 100. In the illustrated example, the thermal image sensor 110 is located in the center of the image forming apparatus 100. However, the thermal image sensor 110 may be implemented to be located on an operation panel in which the input device is located. Further, the arrangement position of the thermal image sensor 110 may be changed according to the size and type of the image forming apparatus 100.

It has been described in the example that only one thermal image sensor 110 is included. However, the thermal image sensor 110 may be implemented to include a plurality of thermal image sensors. The plurality of thermal image sensors may be arranged in positions close to each other or positions spaced apart from each other. The plurality of sensors may be implemented using the same type of thermal image sensor or different sensors from each other.

Since the image forming apparatus 100 may be used by a plurality of users, the image forming apparatus 100 may be located in a place that is easily accessible by the users. For example, when the image forming apparatus 100 is located in a corridor through which the users move, the operation state of the image forming apparatus 100 may be maintained in the normal state or the stand-by state based on user detection around the image forming apparatus 100 without use of the image forming apparatus 100. Thus, unnecessary power consumption may be caused.

The processor 130 may determine whether the user passes through or approaches the image forming apparatus 100 in consideration of a moving form of the detected user and switch the operation state of the image forming apparatus 100 to the normal state or the stand-by state only when the user approaches the image forming apparatus 100.

For example, when a region in which the user is detected is continuously increased in the thermal image information measured through the thermal image sensor over time and the region has a size equal to or larger than a preset size, the processor 130 may determine that the user approaches the image forming apparatus 100 and may switch the operation state of the image forming apparatus 100 to the normal state or the stand-by state.

When the user moves laterally without a change in the size of the region in which the user is detected, the processor 130 may determine that the user passes by the image forming apparatus 100 and may not switch the operation state of the image forming apparatus 100 to the normal state or the stand-by state.

FIG. 5 is a diagram illustrating thermal image information measured through a thermal image sensor according to an example.

Referring to FIG. 5, screen (a) illustrates an example in which thermal image information 510 measured in a plurality of regions satisfies a preset thermal image range. The processor 130 may detect the user using the thermal image information 510 that satisfies the preset thermal image range.

Screen (b) illustrates an example in which partial regions 530 out of thermal image information 520 measured in a plurality of regions do not satisfy the preset thermal image range. The processor 130 may determine the regions 530 that deviate from the preset thermal image range using the measured thermal image information 520. The processor 130 may detect the user using the remaining regions other than the partial regions 530.

An example in which a building window is located in a position corresponding to the partial regions 530 and the partial regions 530 have a temperature of 40 or more degrees due to external solar heat and the like may correspond to the example of a region that deviates from the preset thermal image range. In this example, the processor 130 may incorrectly determine that the user is continuously present in the partial regions 530. Accordingly, it is difficult to detect the user accurately even when the user actually approaches through the partial regions 530.

Another example in which a window is located in a position corresponding to the partial regions 530 and the partial regions have a sub-zero temperature due to the external cold air and the like may correspond to the example of a region that deviates from the preset thermal image range.

Accordingly, the processor 130 may reduce the possibility of erroneous detection of the user by determining whether or not the user is detected through the remaining regions other than the corresponding regions 530.

The processor 130 may determine that the user is approaching when it is determined that a region in which the user is detected within the remaining regions is generated and the corresponding region is gradually increased over time.

The processor 130 may determine that the user moves away when it is determined that a region in which the user is detected within the remaining regions is gradually reduced over time. The user detection method is not limited thereto.

The processor 130 may detect the user using thermal image information for the remaining regions in column units. When the user is approaching or moving away from the image forming apparatus, the portion in which the thermal image information is changed is mainly formed along a column and the processor 130 may more accurately detect the user using the thermal image information of the remaining regions in column units.

For example, the processor 130 may calculate the average value of the thermal image information in the remaining regions in column units and perform the user detection by comparing the calculated average value and the measured thermal image information. The method of using the thermal image information of the remaining regions in column units is not limited thereto.

FIG. 6 is a diagram illustrating an operation of detecting a user using pre-stored thermal image information according to an example.

Referring to FIG. 6, screen (a) illustrates an example of thermal image information measured through the thermal image sensor 110 in a preset timing and pre-stored in the memory 150 and screen (b) illustrates an example explaining an operation of detecting a user using pre-stored thermal image information.

The preset timing may be a turn-on timing of the image forming apparatus or a timing according to preset time period units. The pre-stored thermal image information may have the 2D matrix structure as described above. The thermal image information measured and stored when the user is not detected may refer to background temperature information of the image forming apparatus.

The processor 130 may determine a region that deviates from a preset thermal image range using pre-stored thermal image information 610 and exclude the region.

For example, the processor 130 may determine that regions 620 deviate from the preset thermal image range in the pre-stored thermal image information 610 of screen (a). The processor 130 may determine information of regions 640 located in the same positions of the determined partial regions 620 out of newly measured thermal image information 630 of screen (b) and exclude the thermal image information of the regions 640. The processor 130 may use only position information of the determined partial region 620.

After the processor 130 excludes the determined regions 640 of screen (b) as described above, the processor 130 may detect the user using the thermal image information of the remaining regions.

For example, the processor 130 may determine regions, in which a window and the like are located and a temperature thereof is above 40 degrees due to the solar heat, from the pre-stored thermal image information and detect the user using the thermal image information of the remaining regions other than regions located in the same positions as the determined regions out of the newly measured thermal image information.

Another example in which a window is arranged in a position corresponding to the partial regions and the partial regions have a sub-zero temperature due to the external cold air and the like may correspond to the example of the region that deviate from the preset thermal image range.

The method of detecting the user using the remaining regions in the processor 130 may be performed by comparing the pre-stored thermal image information and the measured thermal image information in the remaining regions other than the regions that deviate from the preset thermal image range.

For example, the processor 130 may determine that the user is detected when the temperature difference between the remaining regions is equal to or larger than a fixed value. The processor 130 may determine that the user is not detected when the temperature difference is not equal to or larger than the fixed value.

The processor 130 may determine whether or not a state in which the temperature difference has the fixed value or more is maintained for a preset time or more and the processor 130 may determine that the user is detected when the state is maintained for the preset time or more and determine that the user is not detected when the state is not maintained for the preset time or more. However, the method of detecting the user is not limited thereto.

The processor 130 may detect the user using the thermal image information for the remaining regions in column units. For example, the processor 130 may calculate the average value of the remaining regions in column units out of the pre-stored thermal image information 610 and perform the user detection by comparing the calculated average value in column units and the remaining regions out of the measured thermal image information 630.

The above-described user detection method may also be applied even when the pre-stored thermal image information corresponds to the background temperature information measured when the user is not detected. The processor 130 may calculate an average value of remaining regions in column units out of the background temperature information and perform the user detection by comparing the calculated average value and the remaining regions out of the measured thermal image information 630.

The method of using the thermal image information of the remaining regions in column units is not limited thereto.

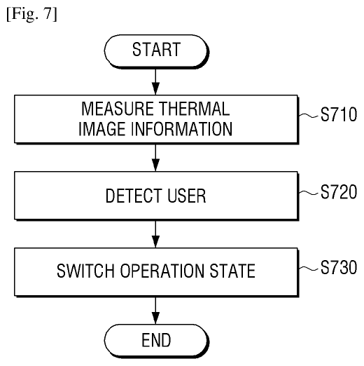

FIG. 7 is a flowchart explaining a control method according to an example.

Referring to FIG. 7, the processor 130 may measure thermal image information in each of a plurality of regions partitioned within a preset region in operation S710. The measured thermal image information may have a 2D matrix structure as illustrated in FIG. 5. The thermal image information may be measured when the image forming apparatus is turned-on or may be periodically measured in preset time period units.

The processor 130 may detect the user using measured thermal image information of the remaining regions other than a region that deviates from a preset thermal image range among the plurality of regions in operation S720.

The method of detecting the user using the thermal image information of the remaining regions other than the region that deviates from the preset thermal image range has been described in connection with the operation of the processor 130 and thus an overlapping description will be omitted.

The processor 130 may further perform an operation of updating the pre-stored thermal image information in connection with the control method.

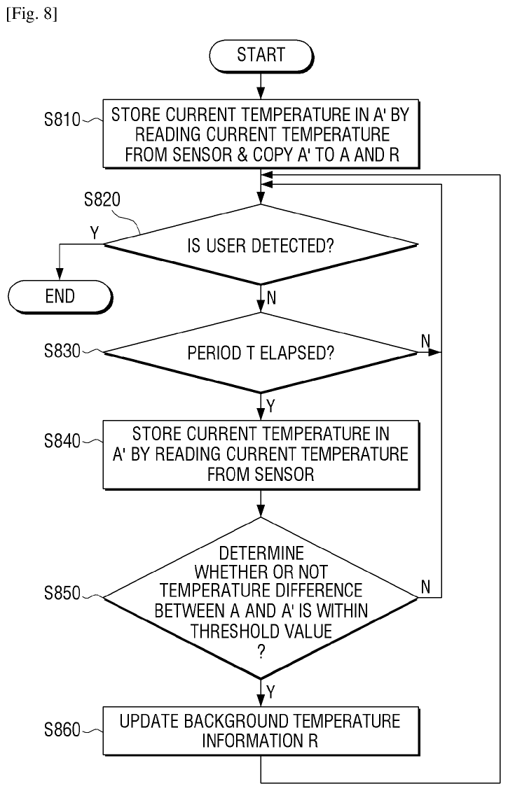

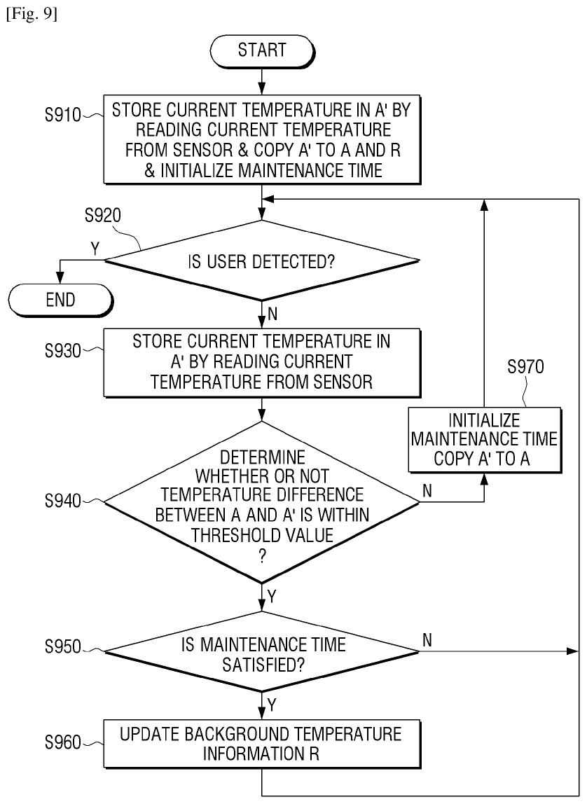

For example, the processor 130 may determine whether or not to update the thermal image information by comparing the measured thermal image information and the pre-stored thermal image information when the user is not detected and store the measured thermal image information when the updating is determined. The process of updating the thermal image information will be described later with reference to FIGS. 8 and 9.

The processor 130 may switch the operation state of the image forming apparatus according to the user detection state in operation S730. For example, when the operation state of the image forming apparatus is the power-saving state and the user is detected, the processor 130 may switch the operation state of the image forming apparatus to the normal state or the stand-by state. When the operation state of the image forming apparatus is the normal state or the stand-by state and the user is not detected, the processor 130 may switch the operation state of the image forming apparatus to the power-saving state.

Accordingly, the control method of an image forming apparatus for detecting the user according to an example may have higher detection accuracy than the related user detection method by detecting the user using only the remaining regions other than the region unnecessary for detecting the user out of the measured thermal image information. For example, the control method of FIG. 7 may be executed by an image forming apparatus having the configuration of FIG. 1 or FIG. 2. In another example, the control method may be executed by an image forming apparatus having a different configuration from the configuration of the image forming apparatus in FIG. 1 or 2.

The above-described control method may be implemented with at least an execution program for executing the control method and the execution program may be stored in a non-transitory computer-recordable recording medium.

The non-transitory computer-recordable medium is not a medium configured to temporarily store data such as a register, a cache, or a memory but an apparatus-readable medium configured to semi-permanently store data. Specifically, the above-described various applications or programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided.

FIG. 8 is a flowchart illustrating a method of updating background temperature information according to an example.

A surrounding or ambient temperature of an image forming apparatus may change over time. When the background temperature information of the image forming apparatus is periodically updated, the change in the surrounding environment of the image forming apparatus may be reflected properly and thus the accuracy of user detection may be enhanced.

All currently measured thermal image information A′, just previously measured thermal image information A, and background temperature information R may have a matrix form configured of a plurality of rows and a plurality of columns as illustrated in FIG. 5.

Referring to FIG. 8, the processor may store the currently measured thermal image information A′ and copy the currently measured thermal image information A′ to the just previously measured thermal image information A and the background temperature information R in operation S810. The process in operation S810 may correspond to a process performed in first turn-on of the image forming apparatus.

The processor may determine if the user is detected using measured thermal image information of the remaining regions other than a region that deviates from a preset thermal image range among the plurality of regions in operation S820. The measured thermal image information may correspond to the currently measured thermal image information A′ or the pre-stored thermal image information.

The method of detecting the user using the thermal image information of the remaining regions other than the region that deviates from the preset thermal image range has been described above in connection with the operation of the processor and thus an overlapping description will be omitted.

When the user is detected as the detection result (S820—Y), the measured thermal image information may not be used as the background temperature information R and thus the updating of the background temperature information R may not be performed and the process may be terminated.

When the user is not detected as the detection result (S820—N), the processor may determine whether or not a preset period of time T has elapsed from the previous updating of the background temperature information R in operation S830. When the previous updating is not performed, the processor may determine whether or not the time elapsed by the period T from the timing that the background temperature information R is first stored.

When it is determined that the time is not elapsed by the period T (S830—N), the processor may determine non-updating timing of the background temperature information and proceed to operation S820 of detecting the user. The currently measured thermal image information A′ may correspond to the just previously measured thermal image information A on the basis of the next measured thermal image information and thus the currently measured thermal image information A′ may be copied to the just previously measured thermal image information A.

When it is determined that the time is elapsed by the period T (S830—Y), the processor may store the currently measured thermal image information A′ in operation S840. The processor may determine whether or not all temperature differences between cells of the currently measured thermal image information A′ and the just previously measured thermal image information A located in the same positions are satisfied with a threshold value by comparing the cells of the currently measured thermal image information A′ and the just previously measured thermal image information A located in the same positions in operation S850.

When a cell of which the temperature difference exceeds the threshold value is determined (S850—N), the processor may not update the background temperature information R and proceed to operation S820 of detecting the user. The currently measured thermal image information A′ may correspond to the just previously measured thermal image information A on the basis of the next measured thermal image information and thus the currently measured thermal image information A′ may be copied to the just previously measured thermal image information A.

When it is determined that all the temperature differences are satisfied with the threshold value (S850—Y), the processor may update the background temperature information R by storing the currently measured thermal image information A′ as the background temperature information R in operation S860.

As described above, the updating of the background thermal image information R may not be performed when the temperature difference exceeds the threshold value by determining the temperature difference between the currently measured thermal image information A′ and the just previously measured thermal image information A. This is because the sudden and abrupt change in the surrounding temperature of the image forming apparatus may be generated. The temperature change may be temporarily generated and when the temporary temperature change is updated as the background temperature information, the possibility of the wrong detection of the user may be increased.

However, when the sudden and abrupt change of the temperature is not temporary and is continuously measured, for example, when a fixed heat source is present, the temperature difference between the currently measured thermal image information and the just previously measured thermal image information may be within the threshold value and thus the background temperature information may be updated.

When the updating of the background temperature information is performed in operation S860, the processor may proceed to operation S820 of detecting the user. The currently measured thermal image information A′ may correspond to the just previously measured thermal image information A on the basis of the next measured thermal image information and thus the currently measured thermal image information A′ may be copied to the just previously measured thermal image information A.

Accordingly, the method of updating the background temperature information according to the example may determine whether or not to update the background temperature information through the temperature information comparison with the just previously measured thermal image information only when the user is not detected and thus the background temperature may be accurately updated and the wrong detection of the user may be prevented. For example, the method of updating the background temperature information illustrated in FIG. 8 may be executed by an image forming apparatus having the configuration of FIG. 1 or FIG. 2. In another example, the method of updating the background temperature information may be executed by an image forming apparatus having a different configuration from the configuration of the image forming apparatus in FIG. 1 or 2.

The above-described control method may be implemented with at least one program for executing the control method and the execution program may be stored in a non-transitory computer-readable medium.

FIG. 9 is a flowchart explaining a method of updating background temperature information according to another example.

The updating method of FIG. 9 may further include determining whether or not to update the background temperature information in consideration of the temperature change maintenance time when the surrounding temperature of the image forming apparatus is changed as compared with the periodic updating method of the background temperature information in FIG. 8. The updating of the background temperature information may be prevented through the updating method of FIG. 9 even when the temperature is temporarily changed.

Referring to FIG. 9, the processor may store the currently measured thermal image information A′, copy the currently measured thermal image information A′ to the just previous measured thermal image information A and the background temperature information R, and initialize a maintenance time in operation S910. The process in operation S910 may correspond to a process performed when the image forming apparatus is first turned on. The maintenance time will be described later with reference to operation S940.

The processor may determine whether the user is detected using measured thermal image information of remaining regions other than a region that deviates from a preset thermal image range among a plurality of regions in operation S920. The measured thermal image information may correspond to the currently measured thermal image information A′ or pre-stored thermal image information.

The method of detecting the user using the thermal image information of the remaining regions other than the region that deviates from the preset thermal image range has been described above in connection with the operation of the processor and thus an overlapping description will be omitted.

When it is determined that the user is detected as a detection result (S920—Y), the currently measured thermal image information may not be used as the background temperature information R and thus the updating of the background temperature information R may not be performed and the process may be terminated.

When it is determined that the user is not detected (S920—N), the processor may store the currently measured thermal image information A′ in operation S930.

A process of determining whether or not the time elapsed by a preset period T from the previous updating of the background temperature information R may be preferentially performed. The process of determining the time passage has been described above with reference to FIG. 8 and thus an overlapping description will be omitted.

The processor may determine whether or not all temperature differences between cells of the currently measured thermal image information A′ and the just previously measured thermal image information A located in the same positions are within a threshold value by comparing the cells of the currently measured thermal image information A′ and the just previously measured thermal image information A located in the same positions in operation S940.

When a cell of which the temperature difference exceeds the threshold value is determined (S940—N), the processor may not update the background temperature information R and proceed to operation S920 of detecting the user. The currently measured thermal image information A′ may correspond to the just previously measured thermal image information A on the basis of the next measured thermal image information and thus the currently measured thermal image information A′ may be copied to the just previously measured thermal image information A.

The processor may initialize the maintenance time when the cell in which the temperature difference exceeds the threshold value is determined in operation S970. The term “maintenance time” may refer to a time that the temperature difference between the currently measured thermal image information A′ and the just previously measured thermal image information A is maintained to be within the threshold value and the maintenance time may be stored in the memory 150. Accordingly, when the cell in which the temperature difference exceeds the threshold value is determined, the processor may initialize the maintenance time.

When all the temperature differences are within the threshold value (S940—Y), the processor may determine whether or not the maintenance time is satisfied with a preset time in operation S950.

The term “preset time” may be a value calculated according to a repetitive experiment result or a value corresponding to an integral multiple of a sampling time of a thermal image sensor used for measuring the thermal image information. For example, when the sampling time of the thermal image sensor is 100 ms, the maintenance time satisfaction condition may be set, for example, to 1 to 3 seconds which are 10 to 30 times of the sampling time.

When the maintenance time is satisfied (S950—Y), the processor may update the background temperature information by storing the currently measured thermal image information A′ as the background temperature information R in operation S960.

When the updating of the background temperature is performed, the process may proceed to operation S920 of detecting the user. The currently measured thermal image information A′ may correspond to the just previously measured thermal image information A on the basis of the next measured thermal image information and thus the currently measured thermal image information A′ may be copied to the just previously measured thermal image information A.

When the maintenance time is not satisfied (S950—N), the processor may not update the background temperature information R and may proceed to operation S920 of detecting the user. The currently measured thermal image information A′ may correspond to the just previously measured thermal image information A on the basis of the next measured thermal image information and thus the currently measured thermal image information A′ may be copied to the just previously measured thermal image information A.

Accordingly, the method of updating the background temperature information according to the example may determine whether or not to update the background temperature information through the temperature information comparison with the just previously measured thermal image information and the satisfaction of the maintenance time only when the user is not detected and thus the background temperature information may be accurately updated and the wrong detection of the user may be prevented. For example, the method of updating the background temperature information illustrated in FIG. 9 may be executed by an image forming apparatus having the configuration of FIG. 1 or FIG. 2. In another example, the method of updating the background temperature information may be executed by an image forming apparatus having a different configuration from the configuration of the image forming apparatus in FIG. 1 or 2.

The above-described control method may be implemented with at least one program for executing the control method and the execution program may be stored in a non-transitory computer-readable medium.

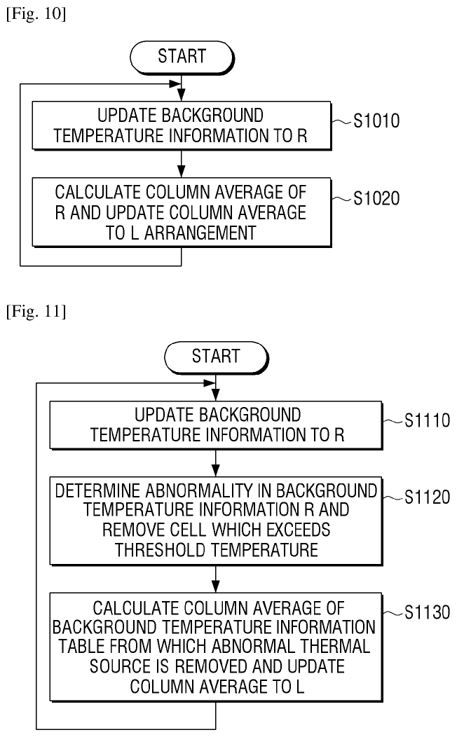

FIG. 10 is a flowchart explaining a method of correcting background temperature information used for user detection according to an example.

Referring to FIG. 10, when the user is detected, the processor may more accurately detect the user not intactly using the pre-stored background temperature information but using the processed background temperature information R.

The processor may update the background temperature information R in operation S1010. The method of updating the background temperature information R may be performed through the above-described method in connection with the updating of the background temperature information R.

The processor may calculate an average value of the updated background temperature information R in column units and update the background temperature information by storing the average value in an average value arrangement L of the background temperature information in column units in operation S1020. When the storage is completed, the processor may proceed to operation S1010 of updating the background temperature information R.

Accordingly, the method of correcting the background temperature information according to the example may detect the user using the average value arrangement L of the background temperature information in column units and may increase the accuracy of user detection. For example, the control method of FIG. 10 may be executed by an image forming apparatus having the configuration of FIG. 1 or FIG. 2. In another example, the control method of FIG. 10 may be executed by an image forming apparatus having a different configuration from the configuration of the image forming apparatus in FIG. 1 or 2.

The above-described control method may be implemented with at least one program for executing the control method and the execution program may be stored in a non-transitory computer-readable medium.

FIG. 11 is a flowchart explaining a method of correcting background temperature information used for user detection according to another example.

The control method of FIG. 11 is the same as the control method of FIG. 10 in that the background temperature information is updated and the user is detected using the average value arrangement L of the background temperature information in column units. However, the control method of FIG. 11 is different from the control method of FIG. 10 in that the average value in column units is calculated with respect to the remaining regions other than a region that deviates from a preset thermal image range out of the updated background temperature information.

Referring to FIG. 11, the processor may update the background temperature information R in operation S1110. The method of updating the background temperature information R may be performed through the above-described method in connection with the updating of the background temperature information R.

The processor may determine the region that deviates from the preset thermal image range in the updated background temperature information R and exclude the region from the background temperature information R in operation S1120.

The processor may calculate the average value in column units with respect to the remaining regions other than the region that deviates from the preset thermal image range and store an average value in an average value arrangement L of the of the background temperature information in column units in operation S1130. When the storage is completed, the processor may proceed to the operation S1110 of updating the background temperature information R.

Accordingly, the method of correcting the background temperature information according to the example may detect the user using the average value of the remaining regions in column units other than the region that deviates from the preset thermal image range out of the background temperature information and may increase the accuracy of user detection as compared with the related user detection method. For example, the control method of FIG. 11 may be executed by an image forming apparatus having the configuration of FIG. 1 or FIG. 2. In another example, the control method may be executed by an image forming apparatus having a different configuration from the configuration of the image forming apparatus in FIG. 1 or 2.

The above-described control method may be implemented with at least one program for executing the control method and the execution program may be stored in a non-transitory computer-readable medium.

The foregoing examples and advantages are merely exemplary and are not to be construed as limiting the present invention. The present teaching can be readily applied to other types of apparatuses. Also, the description of the examples of the present invention is intended to be illustrative, and not to limit the scope of the claims, and many alternatives, modifications, and variations will be apparent to those skilled in the art.

1. An image forming apparatus comprising:
a print engine to form an image;
a thermal image sensor to measure thermal image information for each of a plurality of regions partitioned within a preset region; and
a processor to:
detect a user using the measured thermal image information, and
switch an operation state of the image forming apparatus according to a result of user detection,
wherein the processor detects the user using thermal image information of remaining regions other than a region that deviates from a preset thermal image range among the plurality of regions.

2. The image forming apparatus as claimed in claim 1,
wherein the plurality of regions have a matrix form including a plurality of rows and a plurality of columns, and
wherein the processor detects the user based on average values in column units of the remaining regions other than the region that deviates from the preset thermal image range.

3. The image forming apparatus as claimed in claim 1, wherein the processor determines the region that deviates from the preset thermal image range using the measured thermal image information and detects the user using the measured thermal image information of the remaining regions other than the determined region.

4. The image forming apparatus as claimed in claim 1, further comprising a memory to store thermal image information of the plurality of regions measured in a preset timing,
wherein the processor determines the region that deviates from the preset thermal image range using the thermal image information stored in the memory and detects the user using the measured thermal image information of the remaining regions other than the determined region.

5. The image forming apparatus as claimed in claim 4, wherein the preset timing includes at least one of a turn-on timing of the image forming apparatus or a preset time period unit.

6. The image forming apparatus as claimed in claim 4, wherein the processor determines whether or not to update the thermal image information by comparing the measured thermal image information and the thermal image information stored in the memory when the user is not detected using the measured thermal image information and stores the measured thermal image information in the memory when the updating is determined.

7. The image forming apparatus as claimed in claim 1, wherein the processor detects the user using thermal image information of regions having a temperature range within a preset temperature range other than a region that deviates from the preset temperature range among the plurality of regions.

8. The image forming apparatus as claimed in claim 1, wherein the processor switches the operation state of the image forming apparatus to a stand-by state or a normal state when the user is detected in a state in which the operation state of the image forming apparatus is a power saving state.

9. A method of controlling an image forming apparatus, the method comprising:
measuring thermal image information in each of a plurality of regions partitioned within a preset region;
detecting a user using measured thermal image information of remaining regions other than a region that deviates from a preset thermal image range among the plurality of regions; and
switching an operation state of the image forming apparatus according to a result of user detection.

10. The method as claimed in claim 9,
wherein the plurality of regions have a matrix form including a plurality of rows and a plurality of columns, and
wherein the detecting of the user includes detecting the user based on average values in column units of the remaining regions other than the region that deviates from the preset thermal image range.

11. The method as claimed in claim 9, wherein the detecting of the user comprises:
determining the region that deviates from the preset thermal image range using the measured thermal image information; and
detecting the user using the measured thermal image information of the remaining regions other than the determined region.

12. The method as claimed in claim 9, further comprising storing thermal image information of the plurality of regions measured in a preset timing,
wherein the detecting of the user includes determining the region that deviates from the preset thermal image range using the stored thermal image information and detecting the user using the measured thermal image information of the remaining regions other than the determined region.

13. The method as claimed in claim 12, wherein the preset timing includes at least one of a turn-on timing of the image forming apparatus or a preset time period unit.

14. The method as claimed in claim 12, further comprising determining whether or not to update the thermal image information by comparing the measured thermal image information and the stored thermal image information when the user is not detected using the measured thermal image information,
wherein the storing includes storing the measured thermal image information when the updating is determined.

15. The method as claimed in claim 9, wherein the switching of the operation state includes switching the operation state of the image forming apparatus to a stand-by state or a normal state when the user is detected in a state in which the operation state of the image forming apparatus is a power saving state.
